(19) United States
(12) Patent Application Publication
(10) Pub. No.: US 2008/0184552 A1
(43) Pub. Date: Aug. 7, 2008

(54) Buffer arrangement

(76) Inventor: Gunter Lang, Wernau (DE)

Correspondence Address: RONALD S. LOMBARD;PATENTS AND TRADEMARKS, 4430 TWIN OAKS DRIVE, MURRYSVILLE, PA, 15668, US

(21) Appl. No.: 12/009,777

(22) Filed: Jan. 22, 2008

(30) Foreign Application Priority Data
Feb. 7, 2007 (DE) 10 2007 005 994.0

(51) Int. Cl. B23Q 7/08

(52) U.S. Cl. 29/809; 193/46; 29/823

(57) ABSTRACT

The buffer arrangement according to the invention comprises a slide path (6) for a workpiece carrier (3). Preferably, the slide path (6) is coil-like wound and supported on a central column (15). The slide path (6) comprises preferably at least one slide track (7, 8) and possibly one or several guide tracks (9, 10). The workpiece carriers (3) slide on the slide tracks (7, 8) preferably with the front sides of the centering and clamping bolts disposed on the slide tracks (7, 8).

### CROSS-REFERENCE TO RELATED APPLICATION

This application claims the priority benefits of German Application No. 10 2007 005 994.0 filed Feb. 7, 2007.

### BACKGROUND OF THE INVENTION

The invention resides in a buffer arrangement for workpiece carriers.

In the automatic or partially automatic manufacture, workpieces are often supported by workpiece carriers on which they are moved through the whole manufacturing process or at least a good part thereof without being disconnected from the carrier. Since the machining times may be different in different machine tools as to provide for a certain buffer amount, it may be expedient to provide buffer arrangements which may be arranged ahead of, or after, individual machine tools or which may also be arranged independently for an interim storage of workpieces clamped onto workpiece carriers. These buffer arrangements however should require only little space. Furthermore, they should be simple and reliable and clear in their layout.

It is the object of the present invention to provide a simple buffer arrangement for workpieces carriers.

### SUMMARY OF THE INVENTION

The buffer arrangement according to the invention comprises a slide path (6) for a workpiece carrier (3). Preferably, the slide path (6) is coil-like wound and supported on a central column (15). The slide path (6) comprises preferably at least one slide track (7, 8) and possibly one or several guide tracks (9, 10). The workpiece carriers (3) slide on the slide tracks (7, 8) preferably with the front sides of the centering and clamping bolts disposed on the slide tracks (7, 8).

The buffer arrangement according to the invention includes an inclined slide path on which the workpiece carriers are lined up. Furthermore, it includes a controllable release arrangement arranged at the lower end of the slide path for releasing individual workpiece carriers in a controlled manner.

On the inclined slide path the individual workpiece carriers can slide down until they are backed up at the lower end of the slide path. The slide path, therefore, forms a storage device for one or several workpiece carriers. The storage principle is: first in and first out. An order change of the workpiece carriers in the buffer is not possible. The release arrangement makes it possible that the workpieces collected at the lower end of the slide path are individually released in a controlled manner.

Preferably the slide path includes at least one slide track on which the workpiece carrier can slide down following the slope of the slide path. As slide track preferably a steel track is used on which the clamping bolt of a workpiece carrier is disposed. Generally, the workpiece carriers have at their bottom side, four clamping bolts with a flat or slightly curved lower front face. This front face may be used as slide surface. On one hand, it is smooth and hard and, on the other hand, wear of this front surface is of no importance for any of the functions of the workpiece carrier.

The slide path includes, preferably at least, one slide track. But it may also include several, for example, two slide tracks which extend for example in parallel relationship and which fully support the load of the workpiece carriers. The slide tracks may have guide tracks associated therewith which prevent a sliding off of the clamping bolts from the slide tracks.

In a preferred embodiment, the slide path is coil-like spiraled. In this way a high storage capacity is obtained. In addition, the coil-like spiraled slide path can be supported by a central column which includes radial arms for supporting the slide track. This provides for a simple and clear design. An operator has easy access to the workpiece carriers on the slide track. As a result, a manual interference into the manufacturing process is always possible without causing interruptions of the whole manufacturing process.

The slide track is preferably provided with a carrier lift which is adapted to move the workpiece carriers vertically, individually, or in groups in order to transfer them at the upper end to the slide track. The carrier lift may be, for example, a pneumatic cylinder without piston rod which is oriented vertically and whose carriage includes a fork for accommodating the workpiece carrier.

In a preferred embodiment, a vibration generator is associated with the slide path. This minimizes the static friction between the respective slide surfaces of the workpiece carrier and the slide path. This permits a reduction of the slope of the slide path so that the storage capacity of the buffer arrangement can be maximized.

For linking the buffer arrangement with manufacturing equipment, preferably an automatic handling apparatus is provided. The automatic handling apparatus is preferably designed to take up one workpiece carrier at a time for its transportation. To this end, it includes, for example, a fork which is supported by an X-Y drive, a pivot arm drive, or a similar drive so as to be movable in the space at least horizontally and possibly also vertically.

Further features and advantageous embodiments of the invention will become apparent from the following description thereof on the basis of the accompanying drawings.

### BRIEF DESCRIPTION OF THE DRAWINGS

FIG. 1 shows schematically a buffer arrangement in a perspective view;

FIG. 2 shows the arrangement of FIG. 1 in a schematic side view;

FIG. 3 shows a section of the buffer arrangement according to FIG. 2 in a schematic representation;

FIG. 4 shows enlarged a detail of FIG. 3;

FIG. 5 shows a buffer installation with two linked buffer arrangements;

FIG. 6 is a schematic side view of a handling arrangement; and,

FIG. 7 is a schematic top view of the handling arrangement of FIG. 6.

### DETAILED DESCRIPTION OF AN EMBODIMENT

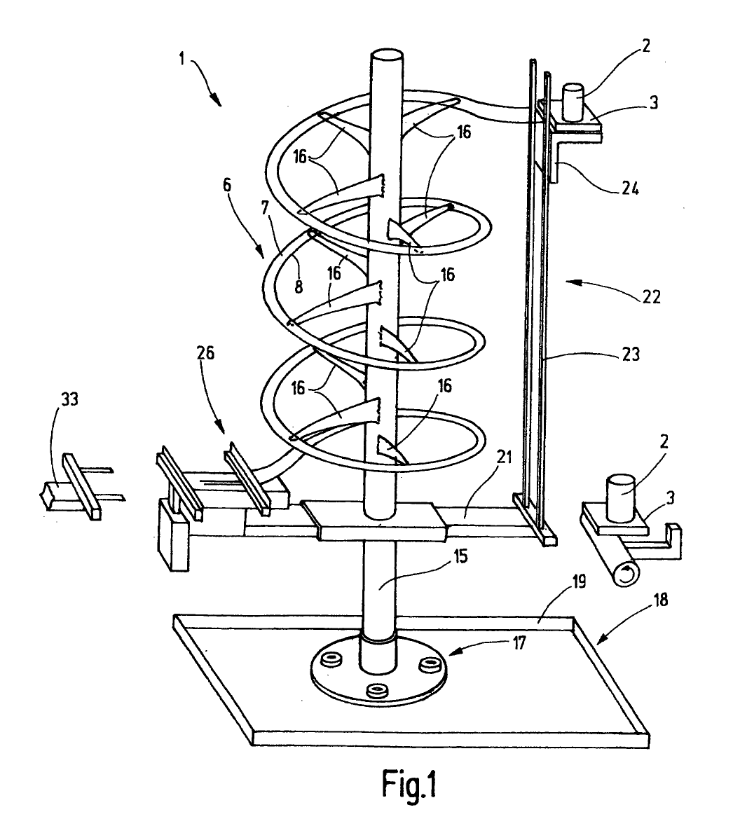

FIG. 1 shows a buffer arrangement 1 which serves as a buffer specifically for workpieces 2, which are clamped onto workpiece carriers 3. In the figures, the workpiece is simply shown as a cylinder. However, the workpiece may have any shape.

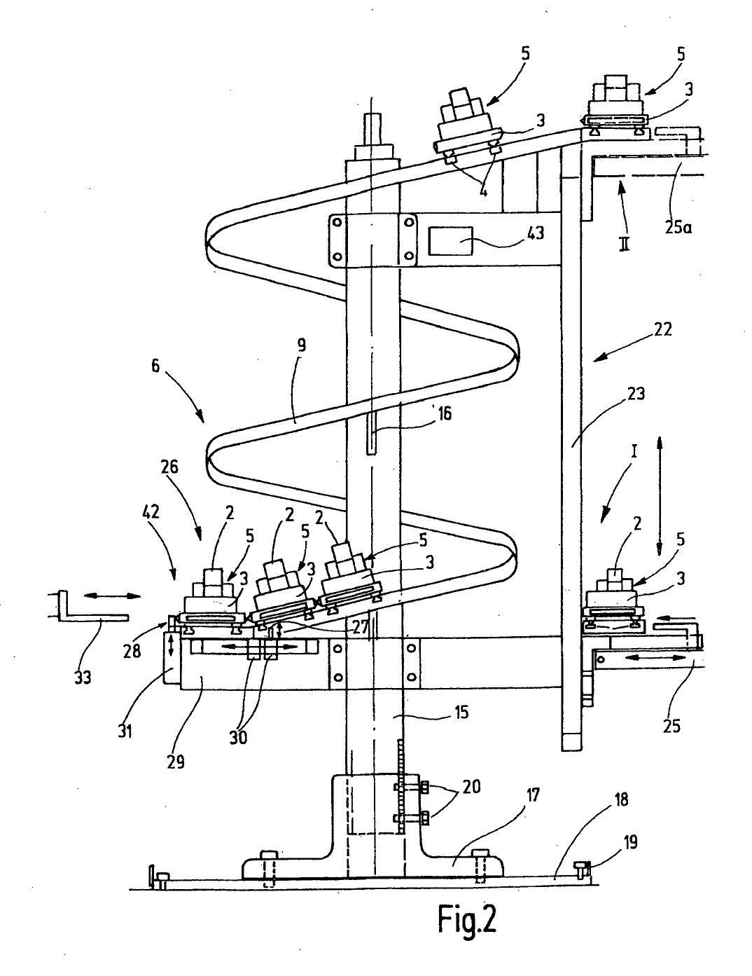

The workpiece carrier 3 consists essentially of a oblong support plate which is oriented horizontally when used, for example, a rectangular plate which is provided at its bottom side with several, for example, four clamping bolts 4 as shown in FIGS. 2, 3, and 4. The clamping bolts 4 are used to position and clamp the workpiece carrier 3 in the machining tools during machining of a respective workpiece 2. For clamping the workpiece to the carrier 3, the carrier 3 is provided at its top side with a clamping arrangement 5 which includes one or more clamping claws which can be locked in clamping position.

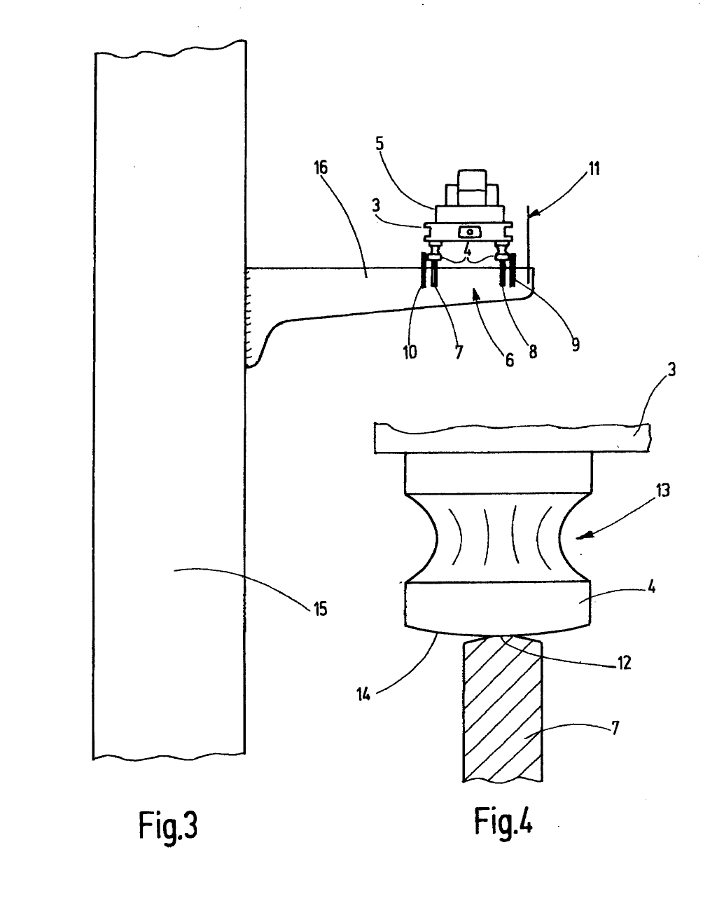

The buffer arrangement 1 comprises for storing the workpiece carriers 3 a sloped slide path 6 as shown in FIGS. 1 and 2. The slope extends preferably over the whole length of the slide path 6 with a constant or changing inclination. Preferably the slide path is helix-shaped. It is formed by at least one, in the shown embodiment however, two slide tracks 7, 8, which extend over the length of the slide path 6 in parallel relationship. The slide tracks 7, 8 are schematically shown in FIG. 1. They are not indicated in FIG. 2. FIG. 2 shows only the outer guide walls 9 with which the glide tracks 7, 8 are provided. A more detailed arrangement of the slide path 6 is shown in FIG. 3. The slide path 6 includes the slide tracks 7, 8, the outer guide wall 9, an inner guide wall 10 and a cover or security sheet 11. The slide tracks 7, 8 and the guide walls 9, 10 preferably have a narrow rectangular cross-section which is oriented vertically. Preferably they consist of a spring steel, spring steel sheet, hardened steel or also a coated steel. FIG. 4 shows the slide track 7 enlarged. It is provided at its upper end with a roof-like shape, so that at its center a slide edge 12 is formed. On this edge 12, the clamping bolt 4, which is provided with a circumferential clamping groove 13 and preferably has a lightly curved support surface 14, is slidably supported. The support surface 14 may also be flat rather than curved. It is preferably fine-machined so as to provide for an accurate vertical positioning. The slide edge 12 may be in the form of a line edge as shown. But the top side of the slide track 7 may also be curved or, respectively rounded.

The slide track 7, 8 may be provided with a coating which reduces wear and/or friction. Herefor hard material coatings or plastic coatings may be used. For example, the slide track 7 may be coated overall or at its upper narrow side with a friction reducing plastic such as polytetrafluorethylen.

The slide tracks 7, 8 are arranged at a distance from each other which corresponds to the distance of the bolts 4 from each other. At both sides of this slide track pair, the guide tracks 9, 10 are arranged which extend upwardly beyond the slide edge 12, so as to guide the clamping bolts 4 at the outsides thereof. Herein a clearance is provided of one or only a few millimeters. The guide tracks 9, 10 are provided overall or at least at their sides facing the clamping bolts 4 with a wear and/or friction reducing coating. As coating a plastic such as polytetrafluorethylen may be used.

The slide track 6 is preferably supported by a stand including a column 15 with radially extending support arms 16. The support arms 16 are, for example, welded to the column 15. They may consist of sheet metal. The column 15 preferably is mounted onto a support foot 17 which is disposed in an oil collecting bin 18. The bin 18 is provided with a circumferential edge 19 for containing oil, cooling lubricants or other fluids dripping from the workpieces 2 or from the workpiece carriers 3, so that it can not reach the support surface. Preferably the support column is height-adjustable as indicated in FIG. 2. To this end, it may be slidably supported in the support foot 17 and clamping screws 20 may be provided for locking the column in a selected vertical position.

Additionally the column 15 preferably carries a horizontal support arm 21 which supports at one end, for example, a pallet lift 22 that includes a vertical guide structure. The pallet lift 22 may be, as shown in FIG. 2, in the form of a piston-rod-free pneumatic cylinder or as indicated in FIG. 1 in the form of, for example, two vertical guide tracks which form a guide path 23. In this case, suitable drive means such as, for example, a belt drive or a linear motor drive may be provided for moving a suitable carriage 24 provided at its top side with means for accommodating the workpiece carrier 3. The pallet lift 22 is adapted to transfer the workpiece carrier 3 from a lower position I to an upper position II. In both positions suitable slide members or other means are provided by which the workpiece carrier 3 can be moved from another transport means such as a transport belt or an automatic handling device onto the carriage 24.

The slide path 6 ends at a release arrangement 26, which includes a first vertically and horizontally movably supported barrier 27 and a second at least vertically movably supported barrier 28. For horizontal movement of the barrier 27 on air cylinder 29 is provided; for vertical movement, there is an air cylinder 30. In FIG. 2, it is shown twice to indicate that it can be moved to two different horizontal elevations. For the vertical movement of the barrier 28, the cylinder 31 is provided.

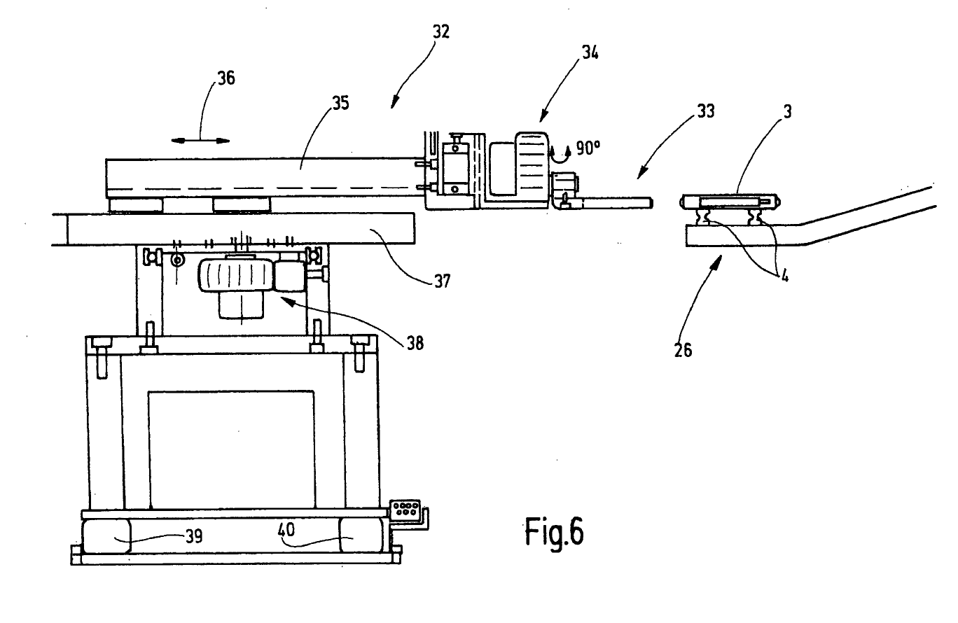

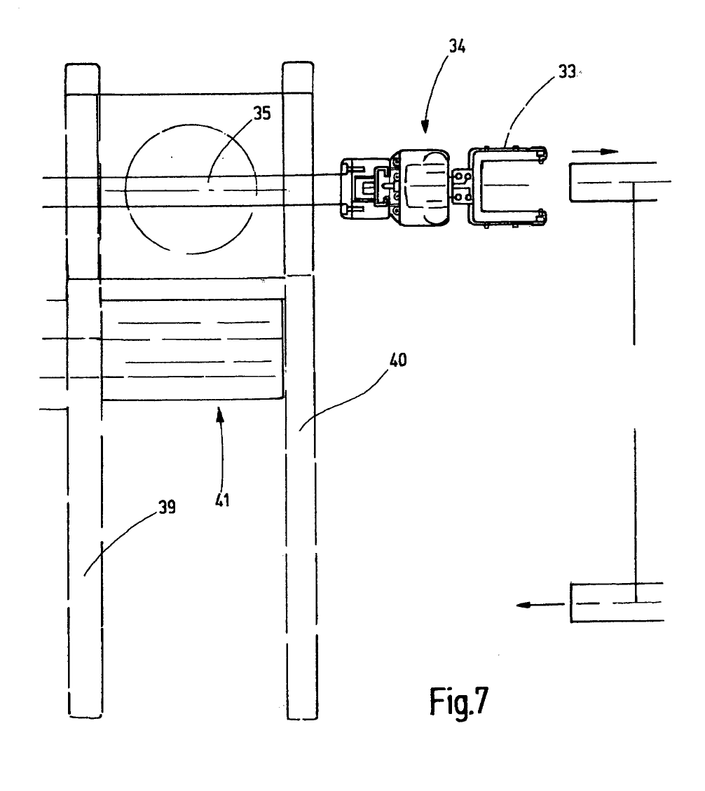

The buffer arrangement 1 further includes a handling arrangement 32 as shown in FIGS. 6 and 7. The handling arrangement 32 comprises a fork 33 which is designed to take over the workpiece carrier 3 from the release arrangement 26. The fork 33 is supported by way of a rotational position control device 34 on an arm 35 which is at least horizontally adjustable. Its movement is indicated in FIG. 6 by an arrow 36. The arm 35 is supported by a support table 37 which is supported rotatably about a vertical axis and can be rotationally positioned by a rotational drive 38. The whole structure is preferably supported on a linear guide structure which may be formed by two cylinders 39, 40. Preferably they generate only a relatively small drive force. The cylinders 39, 40 are preferably provided with a telescopic cover structure 41 capable of supporting a person so that an operator can walk thereon close to the machine. Since the drive force of the two cylinders 39, 40 is only small, the occurrence of accidents is minimized.

The buffer arrangement 1 as described herein operates as follows:

During operation, workpiece carriers 3 with workpieces clamped thereon arrive at the right of FIG. 2 in uniform or non-uniform sequences. A pusher 25 moves the workpiece carrier 3 onto the carriage 24 as soon as it is disposed in the position I. Then the carriage is moved upwardly into the position II. A pusher 25a then moves the workpiece carrier 3 to the beginning, that is the upper end of the slide path 6. On the slide path 6, the workpiece carrier 3 then slides down until it reaches at the bottom end the barrier 27 or it is stopped behind the workpieces carriers 3 already backed up behind the barrier 27. The workpiece carriers 3 may be provided with dampers, for example, in the form of plastic webs which are arranged at the edges of each workpiece carrier 3. Any number of workpiece carriers may be disposed on the slide path. They may be backed up occasionally up to the upper end of the slide path.

The release arrangement permits in each case the transfer of one workpiece carrier 3 to a delivery location 42. From this location, the workpiece carrier 3 can be removed as soon as the barrier 28 is moved down. The fork 33 can pick up the workpiece carrier and transfer it, for example, to a processing machine. The barrier 27 holds the next workpiece carrier 3 in a waiting position. For the release of another workpiece carrier 3, the barrier 28 is again moved up to its upper position and the barrier 27 is moved down. The chain of the backed-up workpiece carriers 3 then slides on a distance corresponding to the length of a workpiece carrier 3.

The sliding of the workpiece carrier 3 can be facilitated by a vibration generator 43 which induces, for example, a vibration movement in the column 15.

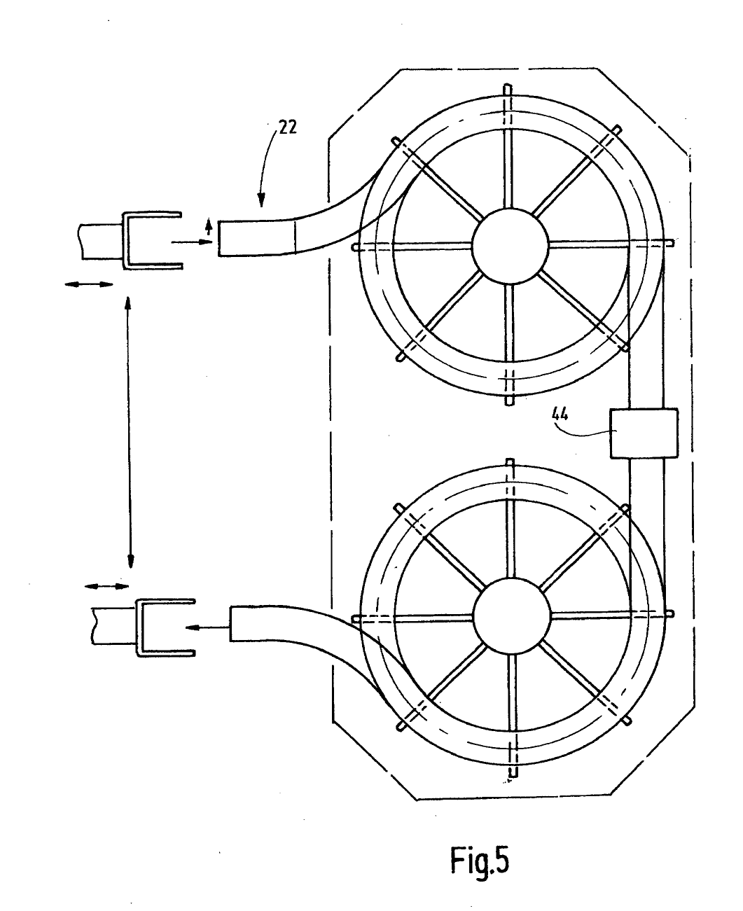

FIG. 5 discloses a modified embodiment of a buffer installation with two buffer arrangements as it is known. In contrast to the known buffer arrangement, however, the two buffers are interconnected by an intermediate plate lift 44. In addition, they may both be supported in a common oil pan. Otherwise, the above description applies also to the case.

The buffer arrangement according to the invention includes a slide path 6 for workpiece carriers. Preferably, the slide path is helix-shaped and is supported by a central column. The slide path 6 comprise preferably at least one slide track 7, 8 and, if expedient, one or several guide tracks 9, 10. The workpiece carrier 3 slides on the slide tracks 7, 8 preferably with the front surfaces of the centering and clamping bolts 4.

What is claimed is:

1. Buffer arrangement for workpiece carriers (3) comprising:
a sloped slide path (6) on which the workpiece carriers (3) are lined up; and,
a controllable release arrangement (26) at the lower end of the slide path (6) for releasing individual workpiece carriers (3).

2. Buffer arrangement according to claim 1, wherein workpiece carriers (3) comprise each a workpiece clamping arrangement and at least one clamping bolt (4), slide path (6) including a slide track (7,8) and slide path (6) extends from its beginning to its lower end and is so arranged that the at least one clamping bolt (4) rests with its front side (14) thereof on the slide track (7,8).

3. Buffer arrangement according to claim 1, wherein the slide path (6) is coil-like spiraled.

4. Buffer arrangement according to claim 2, wherein the slide track (7, 8) has an upper slide edge (12).

5. Buffer arrangement according to claim 2, wherein the slide path (6) is provided with at least one guide track (9).

6. Buffer arrangement according to claim 1, wherein the slide path (6) is connected to a pallet lift (22).

7. Buffer arrangement according to claim 1, wherein the release arrangement (26) comprises at least one controlled barrier (27) for the controlled release of the workpiece carrier (3) for its transfer from the slide path (6) to a delivery location (42).

8. Buffer arrangement according to claim 1, wherein the slide path (6) is provided with a vibration generator (43).

9. Buffer arrangement according to claim 1, wherein an automatic handling arrangement (32) is provided for supplying workpiece carriers (3) to, and for releasing them from, the buffer arrangement (1).

10. Buffer arrangement according to claim 9, wherein the automatic handling arrangement (32) includes at least one piston-rod-free air cylinder (39) for moving the automatic handling arrangement (32) in a front horizontal direction and which supports and guides a carriage on which an arm (35) with a pallet fork (33) is pivotally and movably supported.
